(19) United States
(12) Patent Application Publication
(10) Pub. No.: US 2016/0073315 A1
(43) Pub. Date: Mar. 10, 2016

(54) INFORMATION PROCESSING APPARATUS, STORAGE CONTROL APPARATUS, AND INFORMATION PROCESSING METHOD

(71) Applicant: FUJITSU LIMITED, Kawasaki-shi (JP)

(72) Inventor: Hironori KAI, Kawasaki (JP)

(21) Appl. No.: 14/789,169

(22) Filed: Jul. 1, 2015

(30) Foreign Application Priority Data
Sep. 4, 2014 (JP) 2014-180644

(51) Int. Cl. H04W 36/30; H04L 29/06; H04W 76/06

(52) U.S. Cl. CPC H04W 36/30; H04W 76/068; H04L 69/28

(57) ABSTRACT

An information processing apparatus includes a memory configured to store path switching information indicating whether or not to perform switching between multiple paths which are provided between the information processing apparatus and a storage control apparatus coupled to one or more storages, and a timer value corresponding to an error type, in association with each other; and a processor configured to: transmit an input/output request for processing on one of the one or more storages to the storage control apparatus, extract path switching information which is associated with a timer value corresponding to a response time which is a time from the transmission of the input/output request up to the reception of the error response, by referring to the memory, when an error response to the input/output request is received, and determine whether or not to perform switching between the multiple paths based on the extracted path switching information.

### CROSS-REFERENCE TO RELATED APPLICATION

This application is based upon and claims the benefit of priority of the prior Japanese Patent Application No. 2014-180644, filed on Sep. 4, 2014, the entire contents of which are incorporated herein by reference.

### FIELD

The embodiments discussed herein are related to an information processing apparatus, a storage control apparatus, and an information processing method.

### BACKGROUND

In an information processing system, a redundant mechanism is introduced to avoid suspension of operations. For example, in an information processing system, multiple fiber channel cables and the like are used to connect a server and a storage apparatus through multiple paths. Therefore, even when a trouble occurs at a certain path in the information processing system, operations may be continued by switching the path to another path.

A technology has been known as a related art in which, for example, in a case where a host communicates with a storage apparatus, when a trouble occurs on a path P1 at a predetermined threshold value or more, the path P1 (switching source path) is switched to another normal path P2 (switching destination path). For example, Japanese Laid-open Patent Publication No. 2006-107151 is disclosed as related art.

In the related art, however, proper processing may not be performed in accordance with an error. For example, even in the case where a trouble occurs on a path a predetermined number of times or more, it may be preferable to perform a retry operation with the same path without switching to another path, depending on the error. Thus, proper processing may not be performed in accordance with an error.

### SUMMARY

According to an aspect of the invention, an information processing apparatus includes a memory configured to store path switching information indicating whether or not to perform switching between multiple paths which are provided between the information processing apparatus and a storage control apparatus coupled to one or more storages, and a timer value corresponding to an error type, in association with each other; and a processor coupled to the memory and configured to: transmit an input/output request indicating a request for processing on one of the one or more storages to the storage control apparatus through one of the multiple paths, extract path switching information which is associated with a timer value corresponding to a response time which is a time from the transmission of the input/output request up to the reception of the error response, by referring to the memory, when an error response to the input/output request is received from the storage control apparatus, and determine whether or not to perform switching between the multiple paths based on the extracted path switching information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of an information processing system according to an embodiment;

FIG. 2 is an explanatory diagram illustrating an example of a system configuration of the information processing system according to an embodiment;

FIG. 3 is a block diagram illustrating an example pf a hardware configuration of a server according to an embodiment;

FIG. 4 is a block diagram illustrating an example of a hardware configuration of a storage control apparatus according to an embodiment;

FIG. 5 is an explanatory diagram illustrating an example of storage content of a timeout management table;

FIG. 6 is an explanatory diagram illustrating an example of storage content of an error-handling management table;

FIG. 7 is an explanatory diagram illustrating an example of storage content of a LUN error counter table;

FIG. 8 is an explanatory diagram illustrating an example of storage content of a path error counter table;

FIG. 9 is a block diagram illustrating an example of a functional configuration of the server according to an embodiment;

FIG. 10 is a block diagram illustrating an example of a functional configuration of the storage control apparatus according to an embodiment;

FIG. 11 is a sequence diagram illustrating an example of a registration operation of the timeout management table according to an embodiment;

FIG. 12 is a sequence diagram illustrating an example of an error-handling processing operation according to an embodiment;

FIG. 13 is a flowchart illustrating an example of a creation processing procedure for the error-handling management table of the server according to an embodiment;

FIG. 14 is a flowchart illustrating an example of an update processing procedure for the timeout management table of the storage control apparatus according to an embodiment;

FIG. 15 is a flowchart illustrating an example of an error-handling processing procedure of the server according to an embodiment;

FIG. 16 is a flowchart illustrating an example of an update processing procedure for an error counter table of the server according to an embodiment; and

FIG. 17 is a flowchart illustrating an example of an error-handling processing procedure of the storage control apparatus according to an embodiment.

### DESCRIPTION OF EMBODIMENTS

Hereinafter, an information processing apparatus, a storage control apparatus, an information processing program, and a storage control program according to embodiments will be described in detail with reference to drawings.

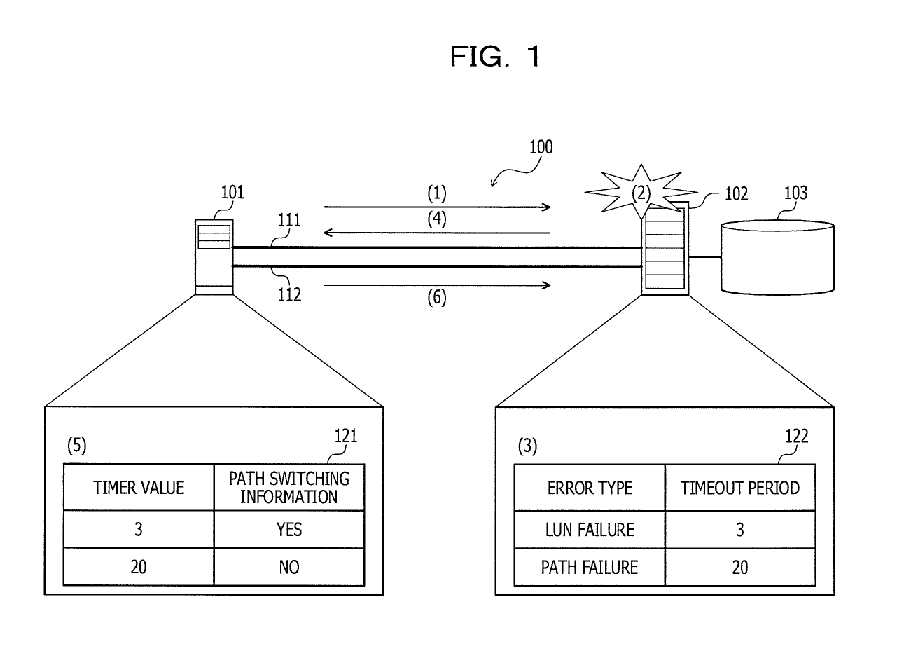

FIG. 1 is an explanatory diagram illustrating an example of an information processing system 100 according to an embodiment. As illustrated in FIG. 1, the information processing system 100 includes an information processing apparatus 101, a storage control apparatus 102, and a storing apparatus 103.

The information processing apparatus 101 is a computer such as a server which issues an input/output request to the storage control apparatus 102. The input/output request is a request for writing data on the storing apparatus 103 or a request for reading data from the storing apparatus 103.

The information processing apparatus 101 is coupled to the storage control apparatus 102 via multiple cables. The cables include, for example, a fiber channel cable, an Ethernet®, a serial attached small computer system interface (SCSI) (SAS) cable, and the like.

The information processing apparatus 101 is coupled to the storage control apparatus 102 through multiple paths (a path 111 and a path 112 in FIG. 1) by using multiple cables. A path is a channel through which an input/output request and a response to the input/output request pass, from the information processing apparatus 101 to the storage control apparatus 102. In the information processing system 100, even in the case where a trouble occurs on one path, operations may be continued by switching to another path.

The storage control apparatus 102 is a computer which is accessible to the storing apparatus 103. The storage control apparatus 102 receives from the information processing apparatus 101 an input/output request to the storing apparatus 103. Then, the storage control apparatus 102 responds to the input/output request by using data held in the storing apparatus 103.

The storing apparatus 103 stores data to be used by the information processing apparatus 101. The storing apparatus 103 may be a physical volume or a logical volume. The physical volume may correspond to one hard disk or correspond to a partition inside the hard disk. The logical volume is obtained by logically dividing a volume group which is an aggregation of physical volumes. As an identifier for identifying a logical volume, a logical unit number (LUN) may be used.

In a known information processing system in which a server and a storage apparatus are coupled through multiple paths, a multipath driver is implemented on an operating system (OS) to perform switching between paths. The multipath driver is implemented on a layer between a disk driver of the OS and a host bus adapter (HBA) driver. This configuration allows the multipath driver to acquire a detailed type of an occurring error from the HBA driver. Therefore, the multipath driver determines, based on the detailed type of the error, whether or not to perform switching to another path, whether or not to perform a retry operation with the same path, and the like.

The recently released OSs have, by default, an incorporated multipath function which performs switching between paths. However, a multipath function included in an OS by default may not perform detailed error processing. Therefore, storage venders have offered multipath drivers for preforming detailed error processing. A multipath driver of an OS by default for performing a multipath function is implemented on a disk driver. Therefore, multipath drivers by storage venders which replace a multipath function of an OS by default are also implemented on the disk driver.

With this implementation, however, the multipath driver is not able to receive from the HBA driver an occurring detailed error type (an error sense code, an SCSI device status, an HBA detection error, or the like). The multipath driver receives error information from the disk driver. However, the error information is a status indicating an error, which is error input output (EIO), and a detailed error type is unknown. Since the error type is solely EIO when viewed from the multipath driver, the multipath driver performs the same error-handling without fail no matter what type of the occurring error may be. That is, the multipath driver is not able to perform appropriate processing in accordance with the error.

According to the embodiment, the information processing apparatus 101 determines whether or not to perform path switching, in accordance with a response time of an error from the storage control apparatus 102, which is coupled to the information processing apparatus 101 through multiple paths and performs an error response based on a timeout period that corresponds to an error type. Thus, the information processing apparatus 101 may perform appropriate processing in accordance with the error.

Hereinafter, an example of the information processing system 100 according to an embodiment will be described. In the following description, a server 101 is used as an example of the information processing apparatus 101.

(1) The server 101 issues an input/output request to the storage control apparatus 102 through any one of the multiple paths. The server 101 may issue the input/output request through a path randomly selected from among the multiple paths. The server 101 may store an error counter value for each of the multiple paths. The server 101 may issue the input/output request through a path with a small error counter value.

In the example of FIG. 1, the server 101 issues the input/output request to the storage control apparatus 102 through the path 111.

(2) The storage control apparatus 102 detects an error by the input/output request from the server 101. Then, the storage control apparatus 102 identifies the error type of the detected error. The error type is a classified type of error in the storage control apparatus 102 according to the type of the error that occurs to the input/output request, which is received by the storage control apparatus 102 from the server 101. For example, an error occurring on any of the logical volumes is classified as the error type of a LUN failure. An error occurring on any of the paths is classified as the error type of a path failure.

In the example of FIG. 1, the input/output request from the server 101 is a data reading request. The storage control apparatus 102 reads data from the logical volume, and detects an error in the logical volume. The storage control apparatus 102 identifies a LUN failure as the error type of the error.

(3) The storage control apparatus 102 acquires a timeout period which corresponds to the error type from information 122 which associates the error type with the timeout period. Then, the storage control apparatus 102 queues until the acquired timeout period has passed since the reception of the input/output request. The timeout period is a period of time up to the time that the storage control apparatus 102 performs an error response when an error belonging to the error type occurs. The timeout period is set beforehand in accordance with the error type. The timeout period is given, for example, in units of seconds.

In the example of FIG. 1, the error type is a LUN failure, and therefore, the storage control apparatus 102 acquires from the information 122 three seconds as the timeout period. The storage control apparatus 102 queues until three seconds has passed since the reception of the input/output request.

(4) The storage control apparatus 102 performs to the server 101 an error response to the input/output request. The error response is a response which indicates that the input/output request from the server 101 is not normally finished.

In the example of FIG. 1, the storage control apparatus 102 performs to the server 101 the error response to input/output request when three seconds has passed since the issuance of the input/output request by the server 101.

(5) The server 101 calculates the response time of the error response from the storage control apparatus 102. The server 101 refers to information 121 which stores path switching information and a timer value which corresponds to the error type in association with each other. Then, the server 101 acquires the path switching information which corresponds to the calculated response time. The response time is a time between issuance of the input/output request to the storage control apparatus 102 by the server 101 and reception of the error response from the storage control apparatus 102 by the server 101. The timer value is a time set beforehand in accordance with the error type. For the timer value, the same time as the timeout period associated with the error type of the information 122 is set. The timer value is given, for example, in units of seconds.

In the example of FIG. 1, the server 101 acquires three seconds as the time from issuance of the input/output request to the storage control apparatus 102 to reception of the error response from the storage control apparatus 102. The server 101 refers to the information 121 and acquires path switching information which corresponds to three seconds.

(6) The server 101 performs path switching based on the acquired path switching information. The path switching is performing inputting/outputting using a path different from the path that was used for inputting/outputting which causes an error response.

In the example of FIG. 1, since the acquired path switching information indicates “Yes”, the server 101 performs path switching. The server 101 performs inputting/outputting by using the path 112, which is different from the path 111 that was used for the inputting/outputting which causes the error response.

As described above, the server 101 is coupled, through the multiple paths, to the storage control apparatus 102, which performs an error response based on the timeout period which corresponds to the error type. The server 101 stores path switching information which indicates whether or not to perform switching to a path which is to be used for inputting/outputting and the timer value which corresponds to the error type in association with each other. On receiving from the storage control apparatus 102 the error response to the input/output request which has been issued through any one of the multiple paths, the server 101 performs switching to the path to be used for inputting/outputting, based on the path switching information associated with the timer value which corresponds to the response time.

Thus, the server 101 may acquire the path switching information which corresponds to the error type and indicates whether or not to perform path switching. The server 101 may therefore perform appropriate processing in accordance with the error.

The processing of the server 101 described above may be performed by a multipath driver of storage venders. In this case, by replacing the multipath driver of an OS by default with the multipath driver of storage venders, the processing of the server 101 described above may be achieved.

The server 101 calculates the response time of the error response. However, the calculated response time includes a time of communication from the storage control apparatus 102 to the server 101. Therefore, the calculated response time may not match the timer value in the information 121. In such a case, the server 101 may acquire path switching information which corresponds to the timer value that is shorter than and closest to the calculated response time.

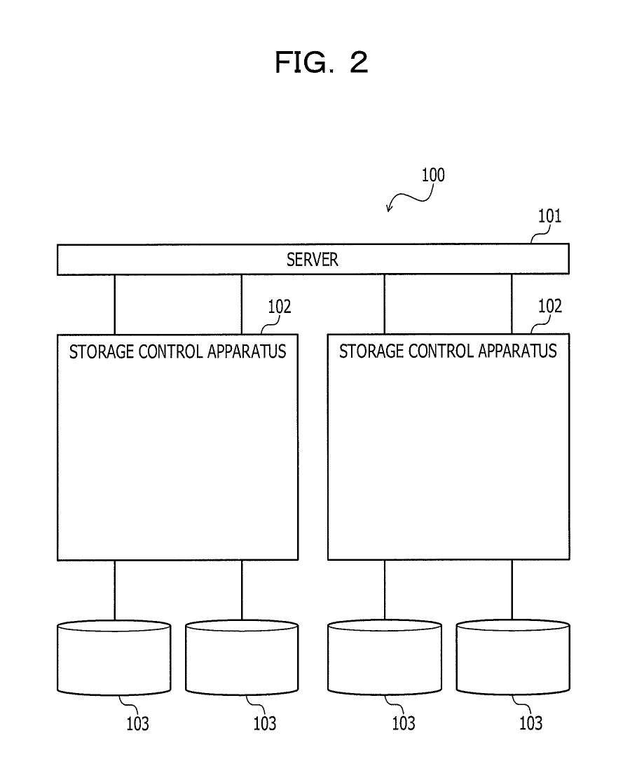

FIG. 2 is an explanatory diagram illustrating an example of a system configuration of the information processing system 100 according to an embodiment. As illustrated in FIG. 2, the information processing system 100 includes the server 101, the storage control apparatus 102, and the storing apparatus 103. The server 101 is coupled to the storage control apparatus 102 via multiple cables.

The server 101 is a computer which accesses the storage control apparatus 102. The storage control apparatus 102 is an apparatus which controls the storing apparatus 103. The storing apparatus 103 is an apparatus which stores data. The storing apparatus 103 is a storing apparatus such as a hard disk apparatus or a disk array apparatus.

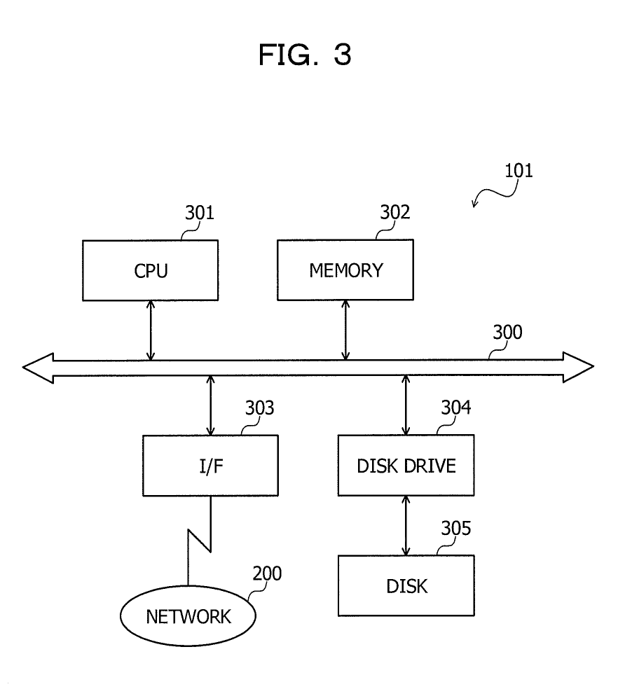

FIG. 3 is a block diagram illustrating an example of a hardware configuration of the server 101 according to an embodiment. As illustrated in FIG. 3, the server 101 includes a central processing unit (CPU) 301, a memory 302, an interface (I/F) 303, a disk drive 304, and a disk 305. The individual components are coupled to each other through a bus 300.

The CPU 301 controls the entire server 101. The memory 302 incudes, for example, a read only memory (ROM), a random access memory (RAM), a flash ROM, and the like. Specifically, for example, the flash ROM and the ROM store various programs. The RAM serves as a storing part and is used as a work area of the CPU 301. The program stored in the memory 302 is loaded onto the CPU 301 and causes the CPU 301 to execute coded processing.

The I/F 303 is connected to a network 200 through a communication line. The I/F 303 is coupled to other computers and the storage control apparatus 102 through the network 200. The I/F 303 functions as an interface between the network 200 and the inside units of the server 101, and controls inputting/outputting of data from other computers. As the I/F 303, for example, a modem, a local area network (LAN) adopter, and the like may be used.

The disk drive 304 controls reading/writing of data from/to the disk 305 under the control of the CPU 301. The disk 305 stores data written under the control of the disk drive 304. The disk 305 may be, for example, a magnetic disk or an optical disk.

The server 101 may include, in addition to the above components, a solid state drive (SSD), a keyboard, a mouse, a printer, a display, and the like.

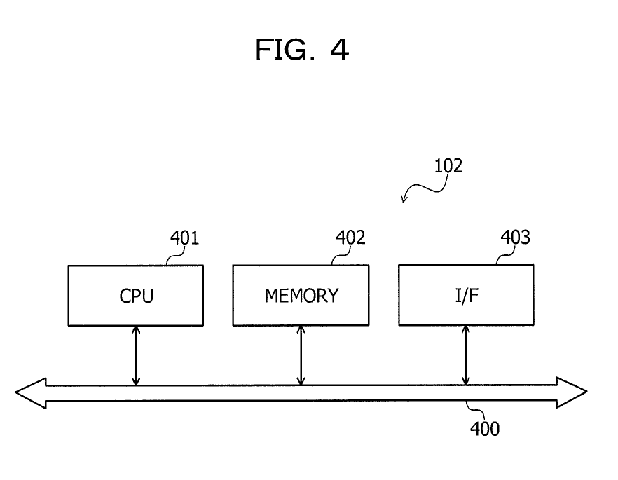

FIG. 4 is a block diagram illustrating an example of the hardware configuration of the storage control apparatus 102 according to an embodiment. As illustrated in FIG. 4, the storage control apparatus 102 includes a CPU 401, a memory 402, and an I/F 403. The individual components are coupled to each other through a bus 400.

The CPU 401 controls the entire storage control apparatus 102. The memory 402 is, for example, a ROM, a RAM, and a flash ROM. Specifically, for example, the flash ROM and the ROM store various programs. The RAM serves as a storing part and is used as a work area of the CPU 401. The program stored in the memory 402 is loaded onto the CPU 401 and causes the CPU 401 to execute coded processing. The I/F 403 is a device which allows connection between the server 101 and the storing apparatus 103.

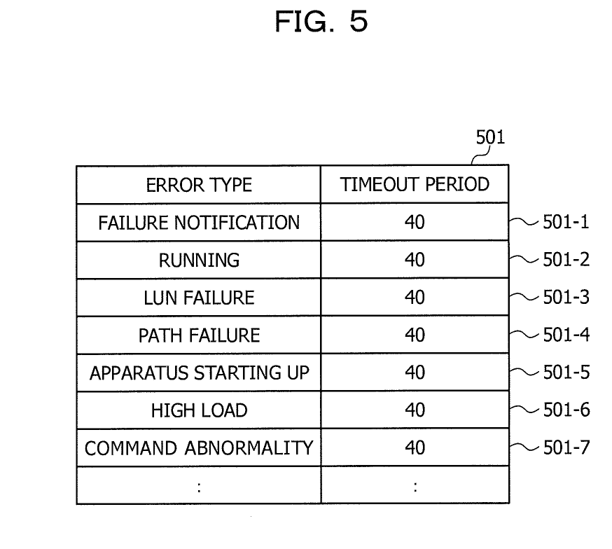

FIG. 5 is an explanatory diagram illustrating an example of storage content of a timeout management table 501. As illustrated in FIG. 5, the timeout management table 501 of the storage control apparatus 102 is, for example, created and updated by the storage control apparatus 102, and stored in the memory 402 of the storage control apparatus 102.

The timeout management table 501 includes entries of an error type and a timeout period. The timeout management table 501 sets information for each entry and thereby stores timeout management information (for example, timeout management information 501-1 to 501-7) as records.

The error type is a classified type of error in the storage control apparatus 102 according to the type of the error that occurs to the input/output request, which is received by the storage control apparatus 102 from the server 101. For example, the error type is, “failure notification”, “running”, “LUN failure”, “path failure”, “apparatus starting up”, “high load”, “command abnormality”, and the like.

The timeout period is a queue time up to the time that the storage control apparatus 102 performs an error response when an error belonging to the error type occurs. The timeout period is given, for example, in units of seconds. Specifically, the timeout period is a period of time from the time at which the input/output request is received from the server 101 by the storage control apparatus 102 to the time at which a response to the server 101 is made to the input/output request.

For example, an initial set value of the timeout period is 40 seconds. The initial set value is changed according to the timer value determined by the server 101 for each error type.

In the example of FIG. 5, a record 501-1 indicates that when an error belonging to the error type of “failure notification” occurs, the storage control apparatus 102 performs an error response to the server 101 after 40 seconds from the time when receiving an input/output request from the server 101.

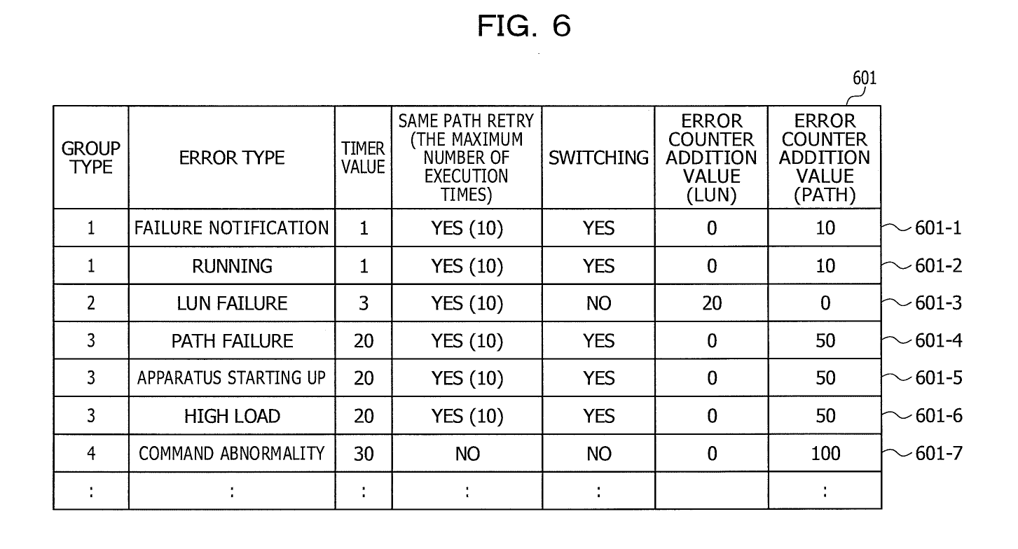

FIG. 6 is an explanatory diagram illustrating an example of storage content of an error-handling management table 601. As illustrated in FIG. 6, the error-handling management table 601 of the server 101 is, for example, created and updated by the server 101, and stored in the memory 302 or the disk 305 of the server 101.

The error-handling management table 601 includes entries of a group type, an error type, a timer value, same path retry (the maximum number of execution times), switching, an error counter addition value (LUN), and an error counter addition value (path). The error-handling management table 601 sets information for each entry and thereby stores error-handling management information (for example, error-handling management information 601-1 to 601-7) as records.

The group type is a classified error type based on the significance of error. The significance of error indicates the extent of the range of effect caused by an error. The larger the significance, the wider the range of effect caused by the error. The error type is a classified type of error according to the type of the error that occurs in the storage control apparatus 102. For the error type, the same content of the error type as the timeout management table 501 is set.

The timer value is a time determined for each error type. The server 101 may determine the timer value based on the significance of error. For example, the server 101 may increase the timer vale as the significance of error becomes larger. The server 101 may set the determined timer value for the timeout period in the timeout management table 501.

The same path retry (the maximum number of execution times) is information which indicates whether or not, when there is an error response from the storage control apparatus 102, to cause the server 101 to perform a retry operation with the same path. The maximum number of execution times is the maximum number of times of retry operation when retry is performed.

The switching is information which indicates whether or not, when there is an error response from the storage control apparatus 102, to cause the server 101 to perform switching to another path. The error counter addition value (LUN) indicates a value to be added to an error counter value in a LUN error counter table 701, which will be described later, when there is an error response from the storage control apparatus 102. The error counter addition value (path) indicates a value to be added to an error counter value in a path error counter table 801, which will be described later, when there is an error response from the storage control apparatus 102.

In the example of FIG. 6, a record 601-1 indicates that the error of “failure notification” belongs to the group type “1”. When the error of “failure notification” occurs, the storage control apparatus 102 performs an error response to the server 101 after one second from the time when receiving an input/output request from the server 101. At this time, the server 101 performs a retry operation with the same path a maximum of ten times after receiving the error response. Furthermore, when recovery from an error is not achieved by retry, the server 101 switches the path to another path. The server 101 adds ten to the counter value for the path that has been used for inputting/outputting in the path error counter table 801.

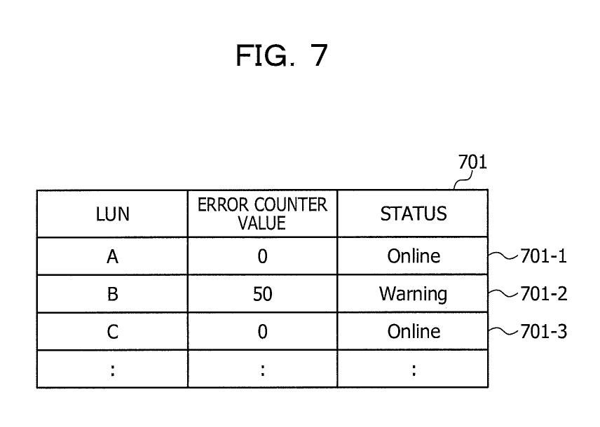

FIG. 7 is an explanatory diagram illustrating an example of storage content of the LUN error counter table 701. As illustrated in FIG. 7, the LUN error counter table 701 of the server 101 is, for example, created and updated by the server 101, and stored in the memory 302 or the disk 305 of the server 101.

The LUN error counter table 701 includes entries of a LUN, an error counter value, and a status. The LUN error counter table 701 sets information for each entry and thereby stores LUN error counter information (for example, LUN error counter information 701-1 to 701-3) as records.

A LUN is an identifier for identifying a logical volume of the storing apparatus 103. The error counter value is a cumulative total of error counter addition values (LUN) in the error-handling management table 601, corresponding to errors occurring to an input/output request to the logical volume identified by the LUN. The status indicates the status of the logical volume identified by LUN, from normal to failure. The status is determined based on the error counter value. For example, the status is an Online status, a Warning status, or a Fail status.

The server 101 may initialize the error counter value at a regular time interval. The server 101 may initialize an error counter value which is at or below a predetermined value at a regular time interval. The status may be defined as, for example, the Online status when the error counter is 0 or more and less than 10, the Warning status when the error counter is 10 or more and less than 80, and the Fail status when the error counter is equal to or more than 80.

In the example of FIG. 7, a record 701-1 indicates that a logical volume identified by a LUN of A has an error counter value of 0 and a status of the Online status.

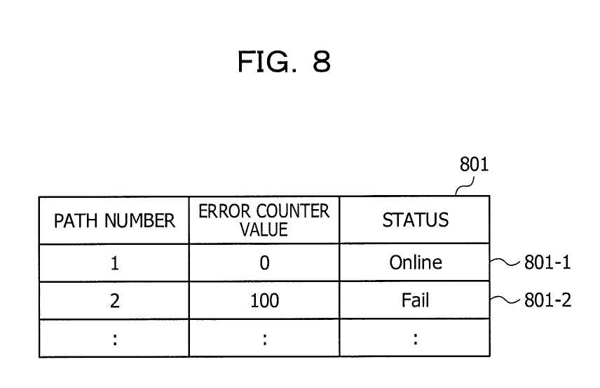

FIG. 8 is an explanatory diagram illustrating an example of storage content of the path error counter table 801. As illustrated in FIG. 8, the path error counter table 801 of the server 101 is, for example, created and updated by the server 101, and stored in the memory 302 or the disk 305 of the server 101.

The path error counter table 801 includes entries of a path number, an error counter value, and a status. The path error counter table 801 sets information for each entry and thereby stores path error counter information (for example, path error counter information 801-1 to 801-2) as records.

The path number is an identifier for identifying a path coupled to the storage control apparatus 102. The error counter value is a cumulative total of error counter addition values (path) in the error-handling management table 601 corresponding to errors occurring on the path identified by the path number. The status indicates the status of the path, from normal to failure. The status is determined based on the error counter value. For example, the status is an Online status, a Warning status, or a Fail status.

The server 101 may initialize the error counter value at a regular time interval. The server 101 may initialize the error counter value which is at or below a predetermined value at a regular time interval. The status may be defined as, for example, the Online status when the error counter is 0 or more and less than 10, the Warning status when the error counter is 10 or more and less than 80, and the Fail status when the error counter is equal to or more than 80.

The server 101 may determine the path based on the error counter value when selecting the path for issuing an input/output request. For example, the server 101 may select a path with the smallest error counter value as the path for issuing an input/output request.

In the example of FIG. 8, a record 801-1 indicates that the path of the path number 1 has an error counter value of 0 and a status of the Online status.

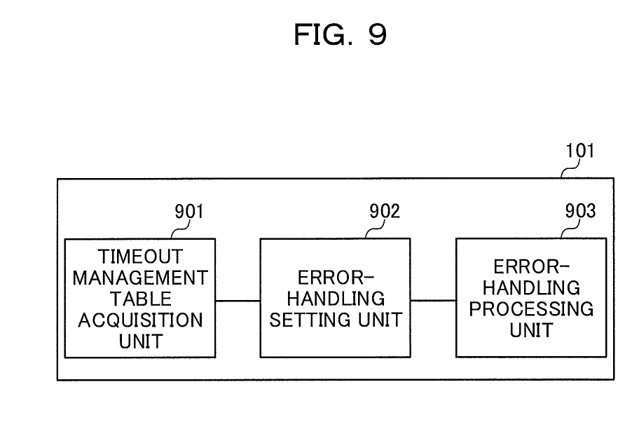

Next, an example of the functional configuration of the server 101 illustrated in FIG. 2 will be described. FIG. 9 is a block diagram illustrating an example of the functional configuration of the server 101 according to an embodiment. As illustrated in FIG. 9, the server 101 includes a timeout management table acquisition unit 901, an error-handling setting unit 902, and an error-handling processing unit 903. Function units including the timeout management table acquisition unit 901, the error-handling setting unit 902, and the error-handling processing unit 903 implement the functions thereof, specifically, for example, by causing the CPU 301 to execute a program stored in the storing device such as the memory 302 illustrated in FIG. 3. The processing result of each of the function units is stored, for example, in the storing device such as the memory 302 illustrated in FIG. 3.

The timeout management table acquisition unit 901 has a function of acquiring the timeout management table 501 from the storage control apparatus 102. For example, the timeout management table acquisition unit 901 uses a vender-unique command which may be issued to a disk driver of an OS by default and thereby acquires the timeout management table 501 from the storage control apparatus 102.

The timeout management table acquisition unit 901 may acquire the timeout management table 501 from the storage control apparatus 102, for example, when the server 101 is started. The timeout management table acquisition unit 901 may acquire only the error type in the timeout management table 501 from the storage control apparatus 102. This is because the error-handling setting unit 902 does not use the timeout period of the timeout management table 501 set as an initial value.

The error-handling setting unit 902 has a function of creating the error-handling management table 601 based on the acquired timeout management table 501. The error-handling setting unit 902 classifies the error type of the acquired timeout management table 501 into a group type. For example, the error-handling setting unit 902 may classify the error type into a group type according to the significance of error.

The error-handling setting unit 902 sets the timer value, the same path retry, the switching, the error counter addition value (LUN), and the error counter addition value (path) for each group type. The error-handling setting unit 902 may set the timer value, for example, based on the significance of the group type. The error-handling setting unit 902 may set “Yes” for the same path retry with respect to the group type for which it is determined that recovery from an error may be achieved by a retry operation with the same path. The error-handling setting unit 902 may set “Yes” for the switching with respect to the group type for which it is determined that recovery from an error may be achieved by switching to another path.

When the error belonging to the group type is an error related to a logical volume, the error-handling setting unit 902 may set a value for the error counter addition value (LUN) according the significance of error. When the error belonging to the group type is an error related to a path, the error-handling setting unit 902 may set a value for the error counter addition value (path) according the significance of error. For example, the error-handling setting unit 902 may set a larger value for the error counter addition value (LUN) and the error counter addition value (path) for an error with a larger significance.

The error-handling setting unit 902 updates the timeout period of the timeout management table 501 based on the set timer value. The error-handling setting unit 902 sets the timer value of the error-handling management table 601 for the timeout period of the timeout management table 501 for each error type. The error-handling setting unit 902 transmits the updated timeout management table 501 to the storage control apparatus 102. Thus, the server 101 and the storage control apparatus 102 may make the timer value and the timeout period the same value which corresponds to the error type.

The error-handling processing unit 903 has a function of performing processing to an error when an input/output request to the storage control apparatus 102 is responded by the error. Processing to the error includes, for example, performing a retry operation with the same path, switching the path into another path, and notifying the host of the error without performing a retry operation or path switching, and the like. Specifically, in the case of a path failure, recovery from the error may be achieved by path switching. In the case of command abnormality, recovery from the error may not be achieved by preforming a retry operation or path switching. Therefore, the host is notified of the error. The host is, for example, a program which has requested the error-handling processing unit 903 for the input/output request.

The error-handling processing unit 903 calculates a response time, which is a time from an input/output request to an error response. For example, the error-handling processing unit 903 stores the time when an input/output request was issued to the storage control apparatus 102. Then, the error-handling processing unit 903 may calculate the response time based on the stored time and the time when the input/output request was responded by the error.

The error-handling processing unit 903 identifies the timer value which corresponds to the calculated response time by referring to the error-handling management table 601. For example, the error-handling processing unit 903 identifies the timer value that is shorter than and closest to the calculated response time by referring to the error-handling management table 601.

The error-handling processing unit 903 determines, based on the “switching” for the group type of the identified timer value, whether or not to switch to another path. When the “switching” is “Yes”, the error-handling processing unit 903 performs switching to another path. When the “switching” is “No”, the error-handling processing unit 903 does not perform switching to another path.

The error-handling processing unit 903 determines, based on the “same path retry” for the group type of the identified timer value, whether or not to perform a retry operation with the same path. When the “same path retry” is “Yes”, the error-handling processing unit 903 performs a retry operation with the same path. When the “same path retry” is “No”, the error-handling processing unit 903 does not perform a retry operation with the same path. When the maximum number of execution times is specified, the error-handling processing unit 903 performs retry operations up to the maximum number of execution times.

The error-handling processing unit 903 updates the LUN error counter table 701 with the error counter addition value (LUN) for the identified timer value. The error-handling processing unit 903 identifies a LUN of a logical volume used for an input/output request causing an error response. The error-handling processing unit 903 adds the error counter addition value (LUN) for the identified error type to the error counter value for the identified LUN.

When the added error counter value exceeds a threshold value, the error-handling processing unit 903 shifts the status of the LUN in the LUN error counter table 701. For example, the error-handling processing unit 903 may use 10 and 80 for threshold values. When these threshold values are exceeded, the error-handling processing unit 903 shifts the status to the Warning status and the Fail status.

The error-handling processing unit 903 updates the path error counter table 801 with the error counter addition value (path) for the identified timer value. The error-handling processing unit 903 identifies the path number of the path used for an input/output request causing an error response. The error-handling processing unit 903 adds the error counter addition value (path) to the error counter value for the identified path number.

When the added error counter value exceeds a threshold value, the error-handling processing unit 903 shifts the status of the path in the path error counter table 801. For example, the error-handling processing unit 903 may use 10 and 80 for threshold values. When these threshold values are exceeded, the error-handling processing unit 903 shifts the status to the Warning status and the Fail status.

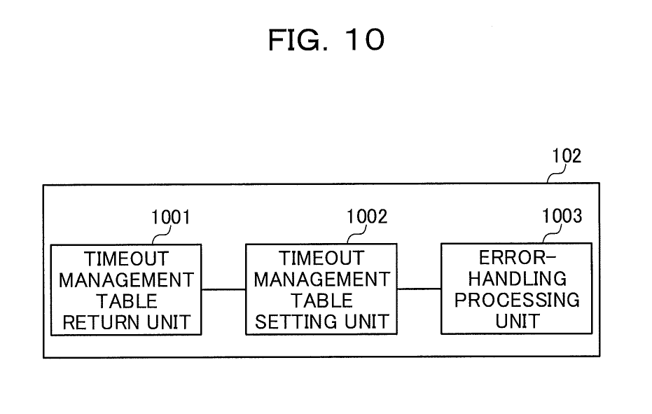

Next, an example of the functional configuration of the storage control apparatus 102 illustrated in FIG. 2 will be described. FIG. 10 is a block diagram illustrating an example of the functional configuration of the storage control apparatus 102 according to an embodiment. As illustrated in FIG. 10, the storage control apparatus 102 includes a timeout management table return unit 1001, a timeout management table setting unit 1002, and an error-handling processing unit 1003. Function units including the timeout management table return unit 1001, the timeout management table setting unit 1002, and the error-handling processing unit 1003 implement the functions thereof, specifically, for example, by causing the CPU 401 to execute a program stored in the storing device such as the memory 402 illustrated in FIG. 4. The processing result of each of the function units is stored, for example, in the storing device such as the memory 402 as illustrated in FIG. 4.

The timeout management table return unit 1001 has a function of returning to the server 101 the timeout management table 501 requested from the server 101. When the error type in the timeout management table 501 is requested from the server 101, the timeout management table return unit 1001 may return only the error type in the timeout management table 501.

The timeout management table setting unit 1002 updates the timeout period in the timeout management table 501 based on the timeout management table 501 transmitted by the server 101. The timeout management table setting unit 1002 may store the updated timeout management table 501 for each server 101. This is because individual timeout periods may be desired to be set for different OS types of the server 101. For example, immediate switching may be preferred for a certain error for a certain type of OS, whereas waiting and seeing for some time without switching may be preferred for a different type of OS.

The error-handling processing unit 1003 has a function of performing processing to an error when the error is caused by an input/output request from the server 101. The error-handling processing unit 1003 identifies the type of the occurring error.

The error-handling processing unit 1003 acquires the timeout period for the identified error type by referring to the timeout management table 501. The error-handling processing unit 1003 queues until the acquired timeout period has passed since the issuance of an input/output request by the server 101. After queueing for the acquired timeout period, the error-handling processing unit 1003 notifies the server 101 of an error response.

When the input/output request from the server 101 is normally finished, the error-handling processing unit 1003 may notify the server 101 of a normal response.

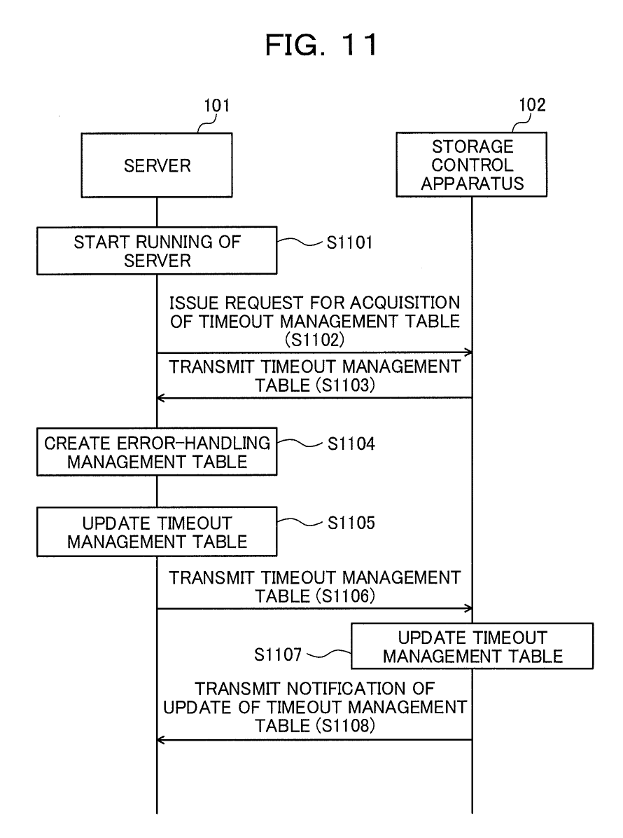

FIG. 11 is a sequence diagram illustrating an example of a registration operation for the timeout management table 501 according to an embodiment. As illustrated in FIG. 11, first, the server 101 starts running (S1101). For example, when a user turns on the power of the server 101, the server 101 starts running.

While running, the server 101 issues to the storage control apparatus 102 a request for acquisition of the timeout management table 501 (S1102). In response to the request, the storage control apparatus 102 transmits the timeout management table 501 to the server 101 (S1103).

The server 101 creates the error-handling management table 601 based on the error type in the timeout management table 501 (S1104). The server 101 updates the timeout period of the timeout management table 501 with the timer value of the error-handling management table 601 (S1105). The server 101 transmits the updated timeout management table 501 to the storage control apparatus 102 (S1106).

The storage control apparatus 102 receives the timeout management table 501. The storage control apparatus 102 updates the timeout period in the timeout management table 501 of the storage control apparatus 102, based on the received timeout management table 501 (S1107). When the update is completed, the storage control apparatus 102 notifies the server 101 of the completion of update of the timeout management table 501 (S1108).

Thus, the series of steps in the sequence diagram of FIG. 11 ends. By performing the above sequence, the server 101 creates the error-handling management table 601. Then, the server 101 may set the timer value corresponding to the error type for the timeout period in the timeout management table 501 of the storage control apparatus 102.

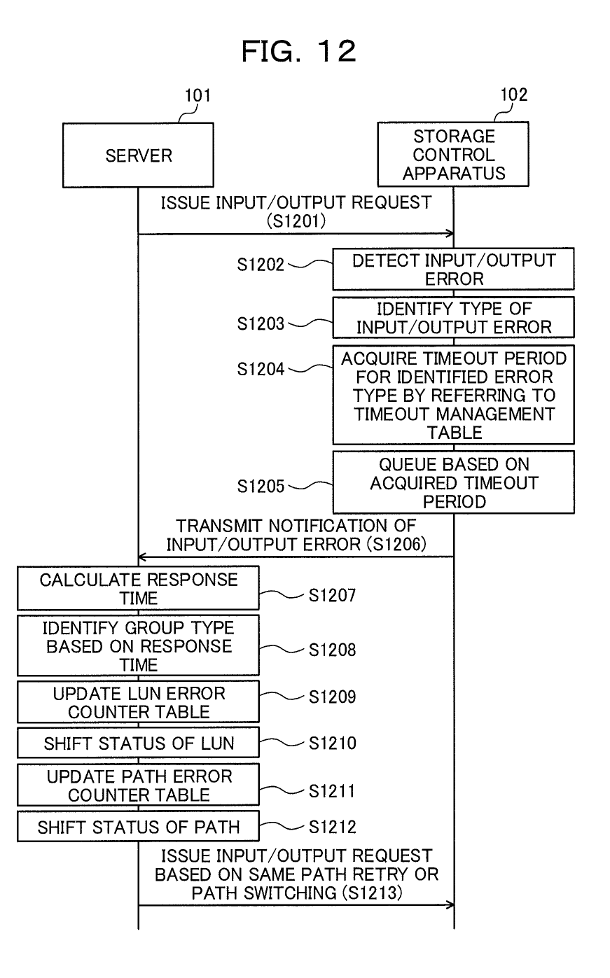

FIG. 12 is a sequence diagram illustrating an example of an error-handling processing operation according to an embodiment. As illustrated in FIG. 12, first, the server 101 issues an input/output request to the storage control apparatus 102 (S1201).

In response to the request, the storage control apparatus 102 performs an input/output operation and detects an input/output error (S1202). Upon detection of the input/output error, the storage control apparatus 102 identifies the type of the input/output error (S1203). The storage control apparatus 102 acquires a timeout period for the identified error type by referring to the timeout management table 501 (S1204).

After that, the storage control apparatus 102 performs queuing based on the acquired timeout period (S1205). For example, the storage control apparatus 102 queues until the acquired timeout period has passed since the issuance of the input/output request by the server 101. After queuing, the storage control apparatus 102 notifies the server 101 of an input/output error (S1206).

The server 101 receives the input/output error, and calculates a response time (S1207). The server 101 identifies a group type based on the calculated response time (S1208). The server 101 updates an error counter value of the LUN error counter table 701 with an error counter addition value (LUN) for the identified group type (S1209). Based on the error counter value of the updated LUN error counter table 701, the server 101 shifts the status of the LUN (S1210).

After that, the server 101 updates an error counter value of the path error counter table 801 with an error counter addition value (path) for the identified group type (S1211). The server 101 shifts the status of the path based on the updated error counter value in the path error counter table 801 (S1212). The server 101 issues an input/output request to the storage control apparatus 102 by the same path or a switched path, based on the same path retry and the switching for the identified group type (S1213).

Thus, the series of steps in the sequence diagram of FIG. 12 ends. By performing the above sequence, the server 101 may perform detailed error processing of performing a retry operation with the same path or performing path switching, based on the response time corresponding to the error type, after the input/output error is received.

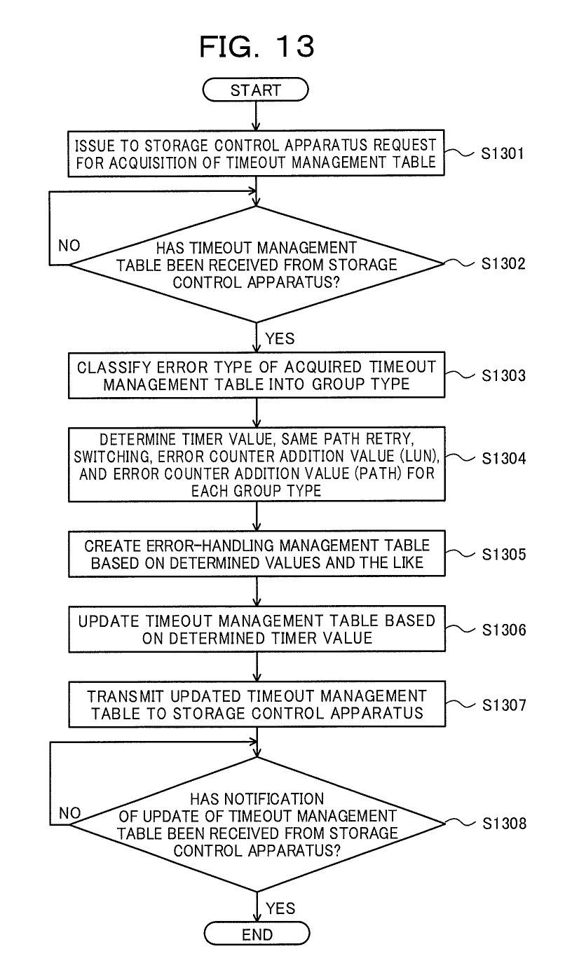

FIG. 13 is a flowchart illustrating an example of a creation processing procedure for the error-handling management table 601 of the server 101 according to an embodiment. As illustrated in FIG. 13, first, the server 101 issues to the storage control apparatus 102 a request for acquisition of the timeout management table 501 (S1301).

The server 101 determines whether or not the timeout management table 501 has been received from the storage control apparatus 102 (S1302). When the timeout management table 501 has not been received from the storage control apparatus 102 (S1302: No), the process of the server 101 returns to S1302.

When the timeout management table 501 has been received from the storage control apparatus 102 (S1302: Yes), the server 101 classifies the error type of the acquired timeout management table 501 into a group type (S1303).

The server 101 determines the timer value, the same path retry, the switching, the error counter addition value (LUN), and the error counter addition value (path) for each group type (S1304). The server 101 creates the error-handling management table 601 based on the determined values and the like (S1305). Furthermore, the server 101 updates the time period of the timeout management table 501 based on the determined timer value (S1306).

The server 101 transmits the updated timeout management table 501 to the storage control apparatus 102 (S1307). The server 101 determines whether or not update notification of the timeout management table 501 has been received from the storage control apparatus 102 (S1308). When it is determined that the update notification of the timeout management table 501 has not been received from the storage control apparatus 102 (S1308: No), the process of the server 101 returns to S1308. When it is determined that the update notification of the timeout management table 501 has been received from the storage control apparatus 102 (S1308: Yes), the creating process for the error-handling management table 601 of the server 101 ends.

Thus, the series of processing in this flowchart of FIG. 13 ends. By performing the above flowchart, the error-handling management table 601 of the server 101 is created.

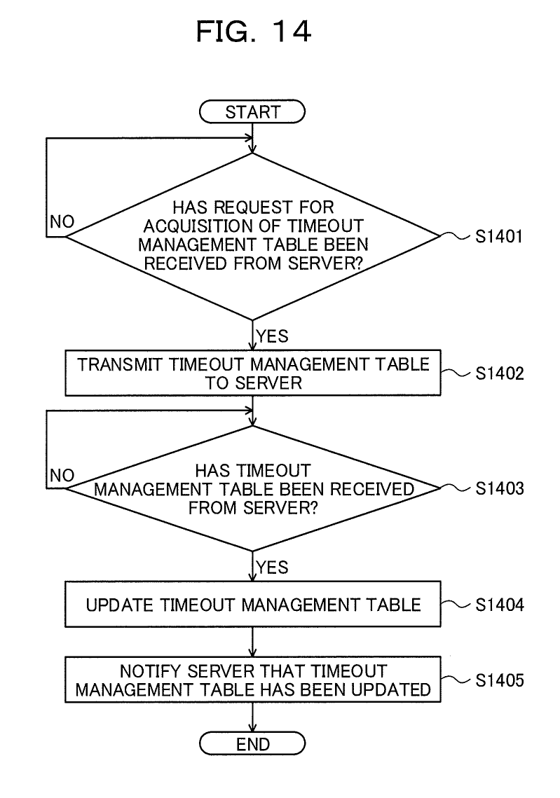

FIG. 14 is a flowchart illustrating an example of an update processing procedure for the timeout management table 501 of the storage control apparatus 102 according to an embodiment. As illustrated in FIG. 14, first, the storage control apparatus 102 determines whether or not a request for acquisition of the timeout management table 501 has been received from the server 101 (S1401).

When it is determined that the request for acquisition of the timeout management table 501 has not been received from the server 101 (S1401: No), the process of the storage control apparatus 102 returns to S1401. When it is determined that the request for acquisition of the timeout management table 501 has been received from the server 101 (S1401: Yes), the storage control apparatus 102 transmits the timeout management table 501 to the server 101 (S1402).

The storage control apparatus 102 determines whether or not the timeout management table 501 has been received from the server 101 (S1403). When the timeout management table 501 has not been received from the server 101 (S1403: No), the process of the storage control apparatus 102 returns to S1403.

When the timeout management table 501 has been received from the server 101 (S1403: Yes), the storage control apparatus 102 updates the timeout management table 501 in the storage control apparatus 102, based on the received timeout management table 501 (S1404). The storage control apparatus 102 notifies the server 101 that the timeout management table 501 in the storage control apparatus 102 has been updated (S1405).

Thus, the series of processing in the flowchart of FIG. 14 ends. By performing the above flowchart, the timer value in the error-handling management table 601 is set for the timeout period in the timeout management table 501 of the storage control apparatus 102.

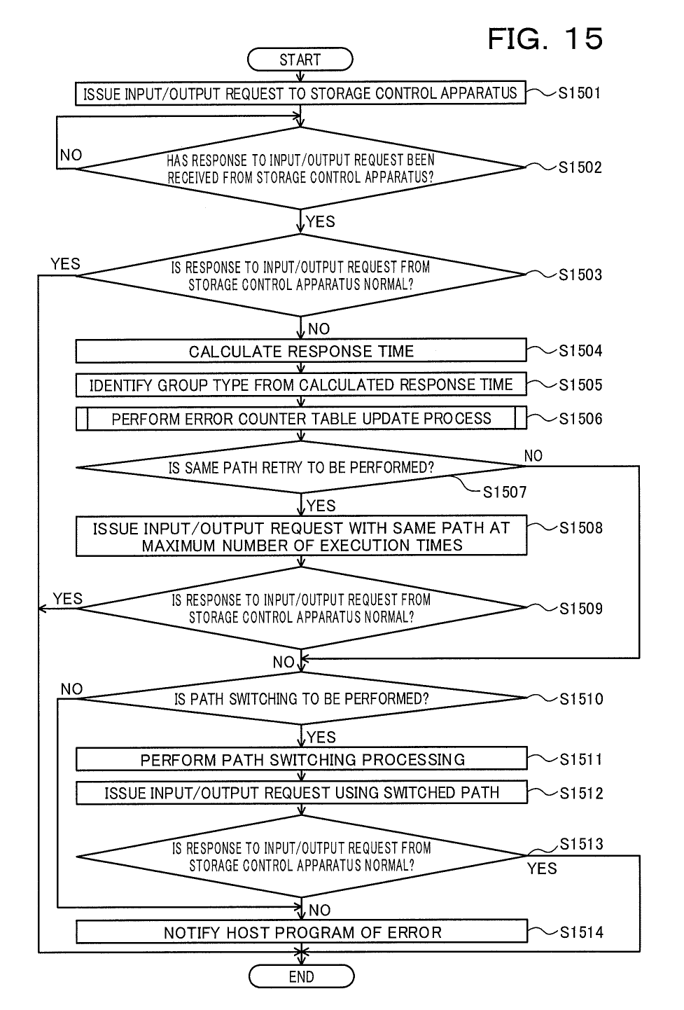

FIG. 15 is a flowchart illustrating an example of an error-handling processing procedure of the server 101 according to an embodiment. As illustrated in FIG. 15, first, the server 101 issues an input/output request to the storage control apparatus 102 (S1501). The input/output request is issued from, for example, a request by a host program.

The server 101 determines whether or not the response to the input/output request has been received from the storage control apparatus 102 (S1502). When it is determined that the response to the input/output request has not been received from the storage control apparatus 102 (S1502: No), the process of the server 101 returns to S1502.

When it is determined that the response to the input/output request has been received from the storage control apparatus 102 (S1502: Yes), the server 101 determines whether the response to the input/output request is a normal response or an error response (S1503). When it is determined that the response to the input/output request is a normal response (S1503: Yes), error-handling is not performed. Therefore, the process of the server 101 ends.

When it is determined that the response to the input/output request is an error response (S1503: No), the server 101 calculates a response time (S1504). For example, the server 101 calculates the response time based on the time at which the input/output request was issued and the time the at which an error response was made to the input/output request.

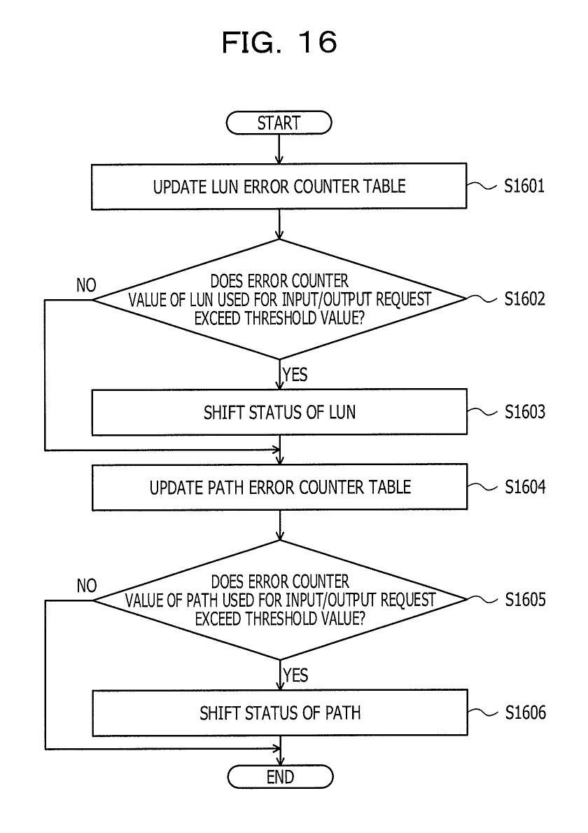

The sever 101 identifies a group type based on the calculated response time (S1505). For example, the server 101 identifies a group type for a timer value corresponding to the calculated response time by referring to the error-handling management table 601. Then, the server 101 updates the LUN error counter table 701 and the path error counter table 801 (S1506). The details of an error counter table updating process by the server 101 will be explained later with reference to FIG. 16.

The server 101 determines whether or not a same path retry is to be performed for an identified error type (S1507). When it is determined that a same path retry is not to be performed for the identified error type (S1507: No), the process of the server 101 proceeds to S1510.

When it is determined that a same path retry is to be performed for the identified error type (S1507: Yes), the server 101 issues an input/output request to the storage control apparatus 102 with the same path as the path with which the input/output request has been issued, up to the maximum number of execution times (S1508). Then, the server 101 determines whether the response to the input/output request is a normal response or an error response (S1509). When it is determined that the response to the input/output request is a normal response (S1509: Yes), the error handing is completed, and the process of the server 101 ends.

When it is determined that the response to the input/output request is an error response (S1509: No), the server 101 determines whether path switching is to be performed for the identified error type (S1510). When it is determined that path switching is not to be performed for the identified error type (S1510: No), the process of the server 101 proceeds to S1514.

When it is determined that path switching is to be performed for the identified error type (S1510: Yes), the server 101 performs processing for switching the path with which the input/output request has issued (S1511). The server 101 issues an input/output request using the switched path (S1512). Then, the server 101 determines whether the response to the input/output request is a normal response or an error response (S1513). When it is determined that the response to the input/output request is a normal response (S1513: Yes), the error-handling is completed, and the process of the server 101 ends.

When it is determined that the response to the input/output request is an error response (S1513: No), the server 101 is not able to recover from the error. Thus, the server 101 notifies the host program, from which the input/output process was requested, of the error (S1514).

Thus, the series of processing in the flowchart of FIG. 15 ends. By performing the above flowchart, detailed error processing of performing a retry operation with the same path or performing path switching may be performed, based on the response time corresponding to the error type, after the input/output error is received.

FIG. 16 is a flowchart illustrating an example of an update processing procedure for an error counter table of the server 101 according to an embodiment. As illustrated in FIG. 16, first, the server 101 updates the LUN error counter table 701 (S1601). Specifically, the server 101 identifies a LUN of a logical volume used for an input/output request causing an error response. The server 101 adds an error counter addition value (LUN) of an identified error type to an error counter value of the identified LUN.

The server 101 determines whether or not the error counter value of the LUN used for the input/output request exceeds a threshold value (S1602). When it is determined that the error counter value does not exceed the threshold value (S1602: No), the process of the server 101 proceeds to S1604. When it is determined that the error counter value exceeds the threshold value (S1602: Yes), the server 101 shifts the status of the LUN in the LUN error counter table 701 (S1603).

After that, the server 101 updates the path error counter table 801 (S1604). Specifically, the server 101 identifies a path number for identifying a path used in the input/output request causing the error response. The server 101 adds an error counter addition value (path) of the identified error type to an error counter value of the identified path number.

The server 101 determines whether or not the error counter value of the path with which the input/output request has been issued exceeds a threshold value (S1605). When it is determined that the error counter value does not exceed the threshold value (S1605: No), the process of the server 101 ends. When it is determined that the error counter value exceeds the threshold value (S1605: Yes), the server 101 shifts the status of the path in the path error counter table 801 (S1606).

Thus, the series of processing in the flowchart of FIG. 16 ends. By performing the above flowchart, after the input/output error is received, the LUN error counter table 701 and the path error counter table 801 are updated.

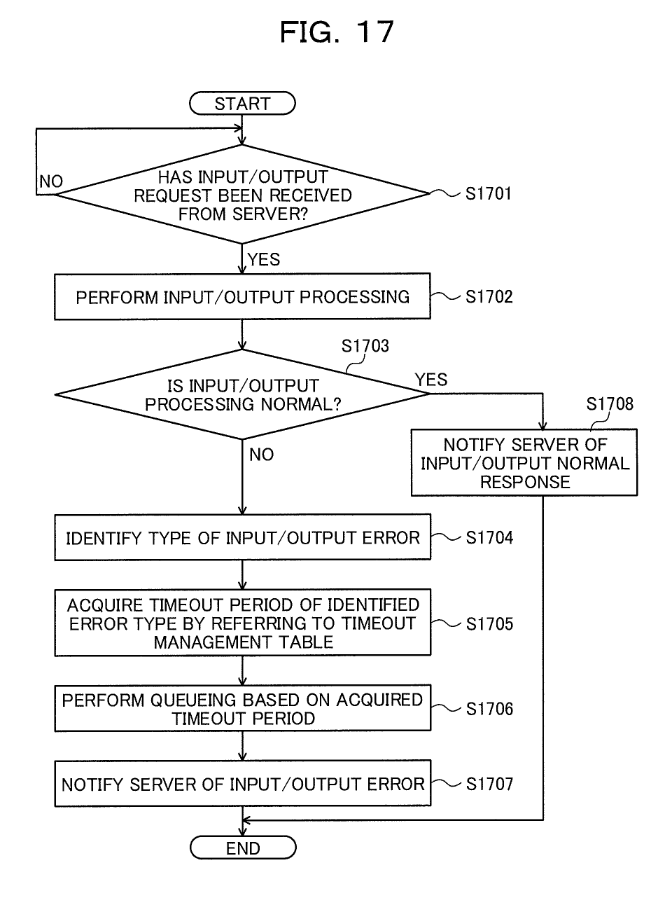

FIG. 17 is a flowchart illustrating an example of an error-handling processing procedure of the storage control apparatus 102 according to an embodiment. As illustrated in FIG. 17, first, the storage control apparatus 102 determines whether or not an input/output request has been received from the server 101 (S1701). When it is determined that the input output request has not been received from the server 101 (S1701: No), the process of the storage control apparatus 102 returns to S1701.

When it is determined that the input/output request has been received from the server 101 (S1701: Yes), the storage control apparatus 102 performs the requested input/output processing (S1702). The storage control apparatus 102 determines whether or not the input/output processing is normal (S1703). When it is determined that the input/output processing is normal (S1703: Yes), the storage control apparatus 102 notifies the server 101 of the normal response to the input/output request (S1708), and the process of the storage control apparatus 102 ends.

When it is determined that the input/output processing is not normal (S1703: No), the storage control apparatus 102 identifies the error type of the input/output error (S1704). The storage control apparatus 102 acquires a timeout period of the identified error type by referring to the timeout management table 501 (S1705).

The storage control apparatus 102 performs queuing based on the acquired timeout period (S1706). For example, the storage control apparatus 102 queues until the acquired timeout period has passed since the issuance of the input/output request by the server 101. After queuing, the storage control apparatus 102 notifies the server 101 of the input/output error (S1707).

Thus, the series of processing in the flowchart of FIG. 17 ends. By performing the above flowchart, when an input/output error occurs in the storage control apparatus 102, the server 101 is notified of the input/output error based on the timeout period corresponding to the error type.

As described above, the server 101 is coupled, through multiple paths, to the storage control apparatus 102 which makes an error response based on the timeout period corresponding to an error type. The server 101 stores path switching information indicating whether or not to switch a path used for inputting/outputting, and a timer value corresponding to the error type, in association with each another. The server 101 performs switching to the path to be used for inputting/outputting, in response to reception of an error response from the storage control apparatus 102 to an input/output request issued through any one of the multiple paths, based on path switching information associated with the timer value corresponding to a response time.

Thus, the server 101 may acquire path switching information corresponding to the error type and indicating whether or not to perform path switching. Therefore, the server 101 may perform appropriate processing in accordance with the error.

The server 101 stores retry information indicating whether or not to perform a retry operation with the same path, and a timer value corresponding to an error type, in association with each other. The server 101 performs a retry operation with the same path, in response to reception of the error response to the input/output request from the storage control apparatus 102, based on the retry information associated with the timer value corresponding to the response time.

Thus, the server 101 may acquire retry information corresponding to the error type and indicating whether or not to perform a retry operation with the same path. Therefore, the server 101 may perform a retry operation with the same path in accordance with the error type.

If the retry information indicates that a retry operation with the same path is not to be performed or if a retry operation with the same path causes an error response, the server 101 may perform switching to the path to be used for inputting/outputting, based on the path switching information.

The server 101 may store the path error counter table 801 that associates each of the multiple paths with a counter value corresponding to the status of the path. Furthermore, the server 101 may store an error counter addition value (path) corresponding to the error type in the error-handling management table 601. The server 101 may, in response to reception of the error response to the input/output request from the storage control apparatus 102, add the error counter addition value (path) to the error counter value associated with the path with which the input/output request has been issued. The server 101 may shift, based on the added error counter value, the status of the path with which the input/output request has been issued.

Thus, the server 101 may manage the status of the path. Therefore, the server 101 may notify the host of the status of the path. Moreover, when selecting the path with which the input/output request is to be issued, the server 101 may determine the path based on the error counter value.

The server 101 may store the LUN counter table 701 that associates a logical volume with a counter value corresponding to the status of the logical volume. Furthermore, the server 101 may store an error counter addition value (LUN) corresponding to an error type in the error-handling management table 601. The server 101 may, in response to reception of the error response to the input/output request from the storage control apparatus 102, add the error counter addition value (LUN) to the error counter value associated with the logical volume with which the input/output request has been issued. The server 101 may shift, based on the added error counter value, the status of the logical volume with which the input/output request has been issued.

Thus, the server 101 may manage the status of the logical volume. Therefore, the server 101 may notify the host of the status of the logical volume.

The server 101 may acquire an error type from the storage control apparatus 102. Then, the server 101 may transmit a timer value corresponding to the acquired error type to the storage control apparatus 102. Furthermore, the storage control apparatus 102 may transmit the error type to the server 101, receive the timer value corresponding to the transmitted error type from the server 101, and change the timeout period with the received timer value.

Accordingly, the server 101 and the storage control apparatus 102 may make the timer value and the timeout period the same value which corresponds to the error type.

The information processing program and the storage control program described in the foregoing embodiments may be implemented when a computer such as a personal computer or a work station executes a program prepared beforehand. The information processing program and the storage control program are recorded on a computer-readable recording medium such as a hard disk, a flexible disk, a compact disk read only memory (CD-ROM), a magneto-optical disk (MO), or a digital versatile disk (DVD), and are executed by being read from the recording medium by the computer. The information processing program and the storage control program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory configured to store path switching information indicating whether or not to perform switching between multiple paths which are provided between the information processing apparatus and a storage control apparatus coupled to one or more storages, and a timer value corresponding to an error type, in association with each other; and
a processor coupled to the memory and configured to:
transmit an input/output request indicating a request for processing on one of the one or more storages to the storage control apparatus through one of the multiple paths,
extract path switching information which is associated with a timer value corresponding to a response time which is a time from the transmission of the input/output request up to the reception of the error response, by referring to the memory, when an error response to the input/output request is received from the storage control apparatus, and
determine whether or not to perform switching between the multiple paths based on the extracted path switching information.

2. The information processing apparatus according to claim 1,
wherein the memory is configured to store the timer value and retry information indicating whether or not to perform a retry operation with a same path, in association with each other,
wherein when the retry information which is associated with the timer value corresponding to the response time indicates that a retry operation with the same path is to be performed, the processor performs a retry operation with the same path, and
wherein when the retry information which is associated with the timer value corresponding to the response time does not indicate that a retry operation with the same path is to be performed or when an error response is received from the storage control apparatus as a result of the retry operation with the same path, the processor determines whether or not to perform switching between the multiple paths, based on the path switching information.

3. The information processing apparatus according to claim 1,
wherein the memory is configured to store each of the multiple paths and a counter value corresponding to a status of the path, in association with each other, and store the timer value and an addition value corresponding to the error type, in association with each other, and
wherein when an error response to the input/output request is received from the storage control apparatus, the processor adds an addition value which is associated with the timer value corresponding to the response time to a counter value which is associated with a path with which the input/output request has been issued, and determines, based on the added counter value, a level of a failure of the path with which the input/output request has been issued.

4. The information processing apparatus according to claim 1,
wherein the processor acquires the error type from the storage control apparatus, and transmits a timer value corresponding to the acquired error type to the storage control apparatus.

5. A storage control apparatus comprising:
a memory configured to store an error type and a timeout period corresponding to the error type, in association with each other; and
a processor coupled to the memory and configured to:
receive an input/output request indicating a request for processing on one of one or more storages coupled to the storage control apparatus, from the information processing apparatus through one of multiple paths,
extract a timeout period which is associated with an error type corresponding to a type of the error, by referring to the memory, when an error to the input/output request is detected, and
transmit an error response to the input/output request to the information processing apparatus, when the extracted timeout period has passed since the reception of the input/output request.

6. The storage control apparatus according to claim 5,
wherein the processor transmits the error type corresponding to the type of the error to the information processing apparatus, receives a timer value corresponding to the transmitted error type from the information processing apparatus, and updates information of the extracted timeout period which is stored in the memory, by using the received timer value.

7. The storage control apparatus according to claim 5,
wherein the memory is configured to store, for each of the one or more storages, the error type and the timeout period corresponding to the error type, in association with each other, and
wherein the processor extracts the timeout period which is associated with the error type corresponding to the type of the error and a storage as a target for the input/output request, by referring to the memory, when the error to the input/output request is detected.

8. An information processing method performed by one or more storages, a storage control apparatus that is coupled to the one or more storages, and an information processing apparatus that is coupled to the storage control apparatus through multiple paths, the storage control apparatus including a first memory configured to store an error type and a timeout period corresponding to the error type, in association with each other, and a first processor, the information processing apparatus including a second memory configured to store path switching information indicating whether or not to perform switching between the multiple paths and a timer value corresponding to an error type, in association with each other, and a second processor, the information processing method comprising:
receiving, by the first processor, an input/output request indicating a request for processing on one of the one or more storages from the information processing apparatus through one of the multiple paths;
extracting a timeout period which is associated with the error type corresponding to the type of the error, by referring to the first memory, when an error to the input/output request is detected;
transmitting an error response to the input/output request to the information processing apparatus, when the extracted timeout period has passed since the reception of the input/output request;
extracting, by the second processor, when the error response is received from the storage control apparatus, path switching information which is associated with a timer value corresponding to a response time which is a time from the transmission of the input/output request to the reception of the error response, by referring to the second memory; and
determining whether to perform switching between the multiple paths, based on the extracted path switching information.

9. The information processing method according to claim 8, further comprising:
storing each of the multiple paths and a counter value corresponding to a status of the path, in association with each other, and store the timer value and an addition value corresponding to the error type, in association with each other;
adding an addition value which is associated with the timer value corresponding to the response time to a counter value which is associated with a path with which the input/output request has been issued, when an error response to the input/output request is received from the storage control apparatus; and
determining a level of a failure of the path with which the input/output request has been issued, based on the added counter value.

10. The information processing method according to claim 8, further comprising:
acquiring the error type from the storage control apparatus; and
transmitting a timer value corresponding to the acquired error type to the storage control apparatus.
